(19) United States
(12) Patent Application Publication
(10) Pub. No.: US 2014/0081671 A1
(43) Pub. Date: Mar. 20, 2014

(54) Real-time Provisioning of Actuarial Data

(71) Applicant: Andreas Schaad, Kaiserallee (DE)

(72) Inventor: Andreas Schaad, Kaiserallee (DE)

(73) Assignee: SAP AG, Walldorf (DE)

(21) Appl. No.: 13/618,998

(22) Filed: Sep. 14, 2012

(51) Int. Cl. G06Q 40/08

(52) U.S. Cl. 705/4

(57) ABSTRACT

Implementations of the present disclosure include methods, systems, and computer-readable storage mediums for providing insurance information for one or more platforms, each platform hosting at least one computer-implemented service. Implementations include actions of identifying one or more risks associated with the at least one computer-implemented service, identifying one or more mitigation mechanisms associated with at least one risk of the one or more risks, providing actuarial data based on the one or more mitigations mechanisms and the at least one risk, transmitting the actuarial data to one or more insurance providers, and receiving insurance premium data, the insurance premium data being provided based on the actuarial data.

### BACKGROUND

Enterprises increasingly conduct business over distributed information technology (IT) systems. For example, an enterprise can offer a computer-implemented service (e.g., a web service) that is hosted on a platform (e.g., a cloud platform). End users, such as customers and/or other enterprises, can access the service. Such computer-implemented services, however, include aspects of risk. For example, a service can be attacked (e.g., by a malicious user) resulting in a shutdown or interruption of user access to the service. As another example, data flow between the user and the service might be susceptible to interception by malicious users. Equally, an attacker may choose to exploit service functionality at the business layer, such as violating a separation of duty control in an ordering process.

One question for such enterprises is how to insure oneself against attacks that may result in the breakdown of such systems, the exposure of user data and/or other detrimental scenarios that could result from providing computer-implemented services. Beyond some limited insurance situations (e.g., insuring against non-availability of a web site), no such insurance schemes exist. More broadly speaking, an effective “cyber-security” insurance market does exist when looking at large business solutions that operate on-premise as well as on-demand.

### SUMMARY

Implementations of the present disclosure include computer-implemented methods for providing insurance information for one or more platforms, each platform hosting at least one computer-implemented service, the methods being performed using one or more processors and including actions of identifying one or more risks associated with the at least one computer-implemented service, identifying one or more mitigation mechanisms associated with at least one risk of the one or more risks, providing actuarial data based on the one or more mitigations mechanisms and the at least one risk, transmitting the actuarial data to one or more insurance providers, and receiving insurance premium data, the insurance premium data being provided based on the actuarial data.

In some implementations, each mitigation mechanism of the one or more mitigation mechanisms includes a mitigation component that is provided on a platform hosting the at least one computer-implemented service.

In some implementations, each mitigation mechanism includes at least one of a technical-level mitigation mechanism and a process-level mitigation mechanism.

In some implementations, the process-level mitigation mechanism mitigates risks associated with a platform hosting the at least one computer-implemented service.

In some implementations, the process-level mitigation mechanism mitigates risks associated with the at least one computer-implemented service.

In some implementations, actions further include executing an orchestration platform component and a landscape management component that perform providing actuarial data.

In some implementations, actions further include executing a service landscape insurance management (SLIM) component that performs providing actuarial data and transmitting actuarial data.

In some implementations, the actuarial data is transmitted to the one or more insurance providers in real-time.

In some implementations, the actuarial data is periodically transmitted to the one or more insurance providers

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 is a block diagram of an example system architecture in accordance with implementations of the present disclosure.

FIG. 2 depicts example information flow in accordance with implementations of the present disclosure.

FIG. 3 is a flowchart depicting an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are generally directed to monitoring actuarial data associated with computer-implemented services hosted on a platform and providing the actuarial data to an insurer that provides insurance coverage. In some implementations, one or more risks are identified for one or more services. One or more mitigation mechanisms are provided to mitigate risks of the one or more risks. In some examples, mitigation mechanisms include mitigation mechanisms that address risks at the technical level and risks at the process level. In some examples, the actuarial data is monitored and provided to the insurer in real-time. In some examples, the actuarial data can be monitored and can be provided to the insurer periodically. In some examples, and based on the actuarial data, insurance policy and/or insurance premium information can be provided.

Implementations of the present disclosure will be described in view of an example context. The example context includes one or more computer-implemented services that an enterprise can make available to users (e.g., customers, other enterprises). In some examples, the computer-implemented services can each be provided as one or more computer-executable programs that are hosted on a platform. In some examples, the platform can be an enterprise-provided platform (e.g., one or more servers provided by the enterprise for hosting the computer-implemented services). In some examples, the platform can be a cloud platform provided by the third-party service provider (e.g., the computer-implemented services of the enterprise are hosted on the cloud platform). In some examples, an end user can use a computing device (e.g., a smartphone, a tablet computer, a laptop computer, a desktop computer) that can execute a client-side application. The client-side application can communicate with one or more computer-implemented services (e.g., hosted on a platform of an enterprise and/or on a cloud platform). The computer-implemented services can receive data from the computing device and/or from other sources (e.g., databases, other computer-implemented services) and can provide data (e.g., a response) to the computing device.

As an example, a computer-implemented service can include a promotional offer management service in the retail domain. In some examples, a retail enterprise can provide promotional offers to end users (e.g., customers). In some examples, the promotional offer management system can receive and/or access customer data to identify one or more promotional offers that may be relevant to a respective customer. As another example, a computer-implemented service can include an invoice approval service in a business domain (e.g., accounting). In some examples, the invoice approval service can be based on a defined business process and can receive and/or access business data to approve/disapprove payment of an invoice. As still another example, a computer-implemented service can include a healthcare service in a medical domain. For example, a healthcare service can provide personal health coaching. In some examples, the healthcare service can receive and/or access medical information associated with a particular user and can provide healthcare coaching to the user.

In some examples, computer-implemented services can access one or more other computer-implemented services provided by other service providers (e.g., other enterprises). For example, an enterprise can provide a recommendation engine that can be accessed be one or more computer-implemented services. With reference to the example promotional offer management service above, the recommendation engine can process data provided by the promotional offer management service to identify promotional offers that may be relevant to a particular customer and can provide the promotional offers back to the promotional offer management service. With reference to the example healthcare service above, the recommendation engine can process data provided by the healthcare service to identify one or more healthcare recommendations (e.g., exercise, dietary) that may benefit a particular patient.

Although implementations of the present disclosure are discussed herein with reference to the example context described above, it is appreciated that implementations are applicable in other contexts. Further, implementations of the present disclosure will be discussed with reference to the example computer-implemented services discussed above. It is appreciated, however, that implementations of the present disclosure are applicable to other computer-implemented service.

In accordance with implementations of the present disclosure, actuarial data associated with computer-implemented services can be monitored and can be provided to an insurer that provides insurance coverage. In some examples, the actuarial data is monitored and provided to the insurer in real-time. In some examples, real-time can describe actions that can be automatically executed (e.g., using one or more computer-executable programs) without requiring human input and without any intentional delay, taking into account the processing limitations of the system executing the actions any time required to process data, for example. In some examples, the actuarial data can be monitored and can be provided to the insurer periodically (e.g., daily, bi-weekly, weekly, bi-monthly, monthly, semi-annually and annually).

In some implementations, actuarial data can include information regarding a landscape associated with an enterprise. In some examples, the landscape can include one or more services provided by the enterprise on a platform, as discussed in further detail below. In some examples, actuarial data can include one or more risks associated with the one or more services. In some examples, actuarial data can include one or more mitigation mechanisms that have been implemented to mitigate the one or more risks. In some examples, actuarial data can include operation data associated with the one or more services. Example operational data can include the number of users accessing a service over a specific period of time (e.g., number of users per day). Further examples of actuarial data can include the number of critical processes (e.g., business processes) being performed through the landscape, the state of data objects per process instance (e.g., real-time state), components that are executing as part of the process, the patch-level of components, application-level security controls (e.g., mutually exclusive roles), use of generic security controls (e.g., encrypted data) and the like. In some examples, actuarial data can include any appropriate combination of the above-referenced example actuarial data.

In some implementations, the actuarial data is provided to an insurer. The insurer can process the actuarial data and can determine one or more insurance policies and respective policy premiums associated therewith. In this manner, both the insured (e.g., an enterprise) as well as the insurer can optimize costs and benefits. For example, an available margin could in part be invested in establishing the initially required infrastructure. As another example, the insured benefits from a tailored insurance premium honoring a willingness to invest into the security of systems and applications (e.g., services). As another example, the insured can equally benefit from recommendations of the insurer that would result in a lower premium (e.g., the insurer can share best practices observed in a peer group of the insured (across a plurality of enterprises). In some examples, the insurer might know that the insured is not going to lower standards as a consequence of being insured. That is, because actuarial data is automatically provided (e.g., in real-time, periodically), the insured is aware that the insurer will remain apprised of the status of the insured system(s). In some examples, the insurer is able to benefit from a possibly lower fee to one or more re-insurers based on the actuarial data from all the insurer's clients (e.g., enterprises).

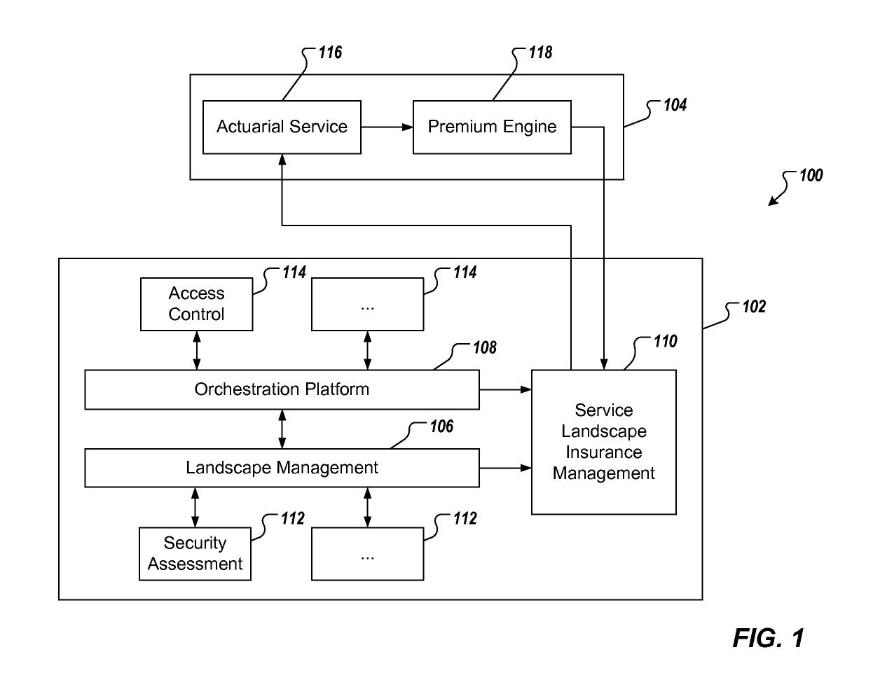

FIG. 1 depicts an example system architecture 100 in accordance with implementations of the present disclosure. In some implementations, the example system architecture 100 can include a platform 102 associated with an enterprise (insured) and an insurance system 104 associated with an insurance provider (insurer). In some implementations, the platform 102 can be provided using one or more computing devices (e.g., server computing devices). In some examples, the platform 102 can be an enterprise-provided platform (e.g., one or more servers provided by the enterprise for hosting computer-implemented services). In some examples, the platform 102 can be a cloud platform provided by a third-party service provider (e.g., one or more servers provided by the third-party service provider for hosting computer-implemented services). In some examples, the platform 102 can be provided as a combination of an enterprise-provided platform and a cloud platform. As discussed in further detail herein, the platform 102 can communicate with the insurance system 104 to provide actuarial data regarding the platform 102. In some examples, one or more server computing devices can execute one or more computer program applications to provide the platform 102.

In some implementations, the platform 102 can provide actuarial data to the insurance system 104. For example, one or more components of the platform 102 can communicate with one or more components of the insurance system 104 over a network (e.g., a local area network (LAN), a wide area network (WAN), the Internet, a cellular network, a telephone network (e.g., PSTN) or an appropriate combination thereof connecting any number of communication devices, mobile computing devices, fixed computing devices and/or server systems). The insurance system 104 can process the actuarial data to provide one or more insurance services to the enterprise associated with the platform 102 (e.g., to provide insurance and to charge insurance premiums determined based on the actuarial data).

Although a single platform 102 and a single insurance system 104 are depicted, it is appreciated that implementations of the present disclosure are applicable in architectures having one or more insurance systems 104 (e.g., each insurance system being associated with a respective insurance provider) and one or more platforms 102 (e.g., each platform being associated with a respective enterprise). For example, an insurance system 102 can provide insurance services to one or more enterprises based on platform-specific actuarial data provided from each of the one or more enterprises. As another example, an enterprise can consume insurance services provided by one or more insurance providers based on platform-specific actuarial data provided to each of the one or more insurance systems 102.

In the depicted example, the platform 102 includes a landscape management component 106, an orchestration component 108 and a service landscape insurance management (SLIM) component 110. In some examples, each of the landscape management component 106, the orchestration component 108 and the SLIM component 110 can be provided as one or more computer-executable programs that can be executed using one or more computing devices (e.g., servers). In the depicted example, the landscape management component 106 communicates with one or more mitigation components 112, and the orchestration platform component 108 communicates with one or more mitigation components 114. Further discussion of the mitigation components 112, 114, and specific examples thereof, are provided below. In some examples, each of the mitigation components 112, 114 can be provided as one or more computer-executable programs that can be executed using one or more computing devices (e.g., servers).

In accordance with implementations of the present disclosure, the platform 102 can host one or more computer-implemented services (not shown) provided by the enterprise. Example services can include the example services introduced above, among any other appropriate service.

In some implementations, the landscape management component 106 can be provided as a centralized support and system management suite. For example, a system landscape can include a number of services and mitigation components 112, 114 (among other components). In some examples, the landscape management component 106 can reduce and centralize the management of the landscape. For example, the landscape management component 106 can be described as the managing system and services and mitigation components 112, 114 can be described as the managed systems. In some examples, the landscape management component 106 provides a set of features for enhancing, automating and improving system management. An example landscape management component 106 can include SAP Solution Manager provided by SAP AG of Walldorf, Germany.

In some implementations, the orchestration platform component 108 enables building and running applications based on service-oriented architecture (SOA) principles. In some examples, the orchestration platform component 108 provides a set of capabilities for integrating new and existing services (e.g., into business-specific solutions). In some examples, the orchestration platform component 108 supports the development of standard-compliant services (applications) (e.g., based on Java Enterprise Edition (Java EE) technologies) and integration of such services with existing enterprise and/or third-party services using a central enterprise service registry. In some examples, the orchestration platform component 108 can provide model-driven composition tools for creating services and user interfaces and orchestrating services into collaborative user-centric workflows. In some examples, and for a particular service, the orchestration platform component 108 can specify a workflow of the service, can define which roles (e.g., user rules) perform which tasks within the workflow, can specify how each task is to be performed and can provide this information to the SLIM component 110. An example orchestration platform component 108 can include SAP Netweaver Composition Environment (CE) provided by SAP AG.

In some implementations, the SLIM component 110 provides mapping and actuarial data collection. More particularly, the SLIM component 110 can receive data regarding services available on the platform 102 from the landscape management component 106 and/or the orchestration platform component 108. In some examples, the SLIM component 110 provides the data received from the landscape management component 106 and/or the orchestration platform component 108, and provides actuarial data based thereon. The SLIM component 110 provides the actuarial data to the insurance system 104 and can receive insurance premium and/or insurance policy information from the insurance system 104. In some examples, the mapping includes an electronic document that maps identified risks to one or more mitigation mechanisms.

In the depicted example, the insurance system 104 includes an actuarial service 116 and a premium engine 118. In some examples, each of the actuarial service 116 and the premium engine 118 can be provided as one or more computer-executable programs that can be executed using one or more computing devices (e.g., servers). In some examples, the actuarial service 116 processes actuarial data to provide insurance relevant information. In some examples, insurance relevant information can include information that can influence one or more types of insurance policies, if any, and/or insurance premiums available for such policies. In some examples, the premium engine 118 processes the insurance relevant information to provide insurance premium and/or insurance policy information to the SLIM component 110.

As introduced above, the platform 102 can host one or more computer-implemented services (not shown) provided by the enterprise. Example services can include the example services introduced above, among any other appropriate service. In some examples, one or more risks can be associated with each computer-implemented service can be associated with one or more risks. In some examples, a risk can include a risk of an unintended and/or undesired event. Example risks can include a breach in a separation of duty (SoD) requirement, a breach in a binding of duty (BoD) requirement, a breach in a need to know requirement, system attach vulnerabilities (e.g., SQL injection, buffer overflows, cross-site scripting (XSS), dynamic code execution that can be influenced by user input, data integrity, authenticity of data communication channels (e.g., data communicated to/from an end user and a service, data communicated between services).

In accordance with implementations of the present disclosure, mitigation mechanisms can be provided to mitigate the identified risks. In some examples, the mitigation mechanisms can include the mitigation components 112, 114. Example mitigation mechanisms can include access control, data encryption and security assessment among other appropriate mitigation mechanisms. As an illustrative example, a mitigation component 112 can provide security assessment functionality that can include automated security assessment of landscape systems, detecting of insecure instance configurations (e.g., ABAP and/or Java), detecting missing security notes and patches, detecting undesirable user authorizations, and/or detecting insecure interfaces between landscape systems. By implementing security assessment functionality, the platform 102 can have improved security, fraud risks can be reduced, compliance requirements can be enforced, and costs can be reduced (e.g., insurance premiums). An example mitigation component that provides security assessment functionality includes Onapsis X1 provided by Onapsis Inc.

As another illustrative example, a mitigation component 114 can include access control. In some examples, access control can be used to automatically detect and remediate access risk violations across hosted services, embed compliance checks and mandatory risk mitigation into processes, provide users with self-service, workflow-driven access requests and approvals, automate reviews of user access, role authorizations, risk violations and control assignments, better manage super-user access controls with a centralized, closed-loop process and create a comprehensive audit trail of user and role management activities.

In some examples, access control can include enforcement of user credentials for users attempting to access one or more services hosted on the platform 102. In some examples, access control can be used to enforce SoD, BoD and/or need to know requirements. With regard to access control, access to resources and/or authorization to perform tasks can be restricted to certain user roles (e.g., clerks, managers) of users. For example, a simple role hierarchy containing the roles staff and manager can be provided, where every member of the role manager is also a member of the role staff. Further, the role staff has full access (e.g., is allowed to claim, execute, or cancel) certain tasks (e.g., within a process provided by a service), and members of the role manager have full access for other tasks. In some examples, SoD can be enforced by ensuring that multiple roles are required to complete a process provided by the service (e.g., in a business domain, a role requesting payment of an invoice must be different from a role that can authorize payment of the invoice). An example mitigation component that can provide access control for hosted services can include SAP Governance, Risk and Compliance (GRC) access control provided by SAP AG.

In accordance with implementations of the present disclosure, one or more risks can be identified for each hosted service and one or more mitigation mechanisms can be provided to mitigate one or more of the identified risks. In some implementations, each risk can be mapped to one or more of the mitigation mechanisms. In some implementations, data that can reflect risk can be mapped to one or more risks. As discussed above, actuarial data can be provided based on the mapping and data values.

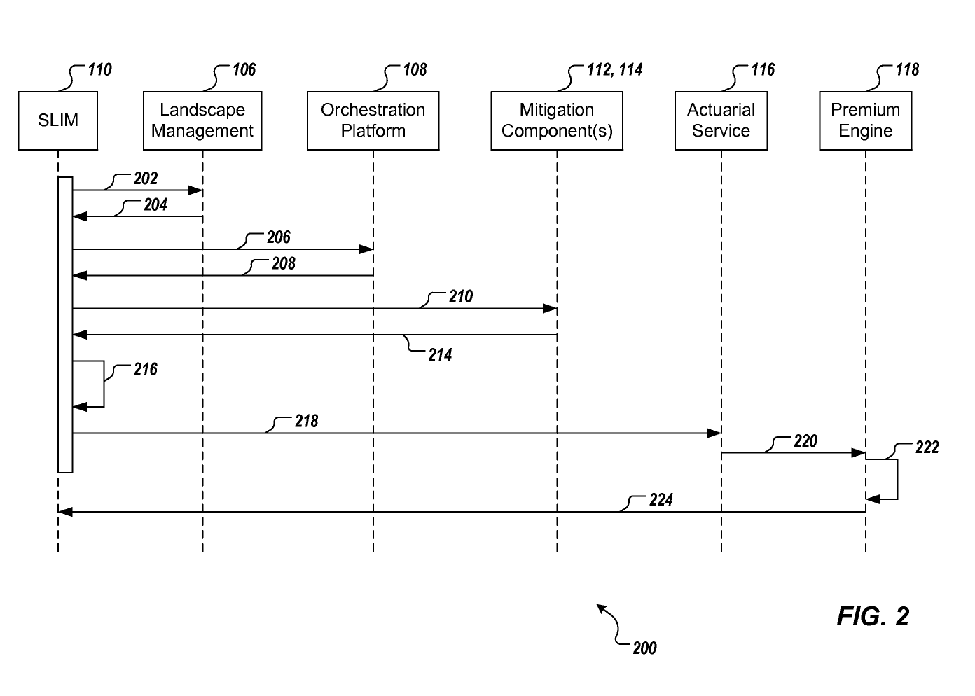

FIG. 2 depicts an example information flow 200 in accordance with implementations of the present disclosure. In some examples, the SLIM component 110 sends a request 202 to the landscape management component 208, which sends a response 204. In some examples, the response 204 includes technical-level data reflecting one or more risks and one or more mitigation components implemented to mitigate the one or more risks (e.g., the mitigation component(s) 112 of FIG. 1). In some examples, the SLIM component 110 sends a request 206 to the orchestration platform component 108, which sends a response 208. In some examples, the response 208 includes process-level data reflecting one or more risks and one or more mitigation components implemented to mitigate the one or more risks (e.g., the mitigation component(s) 114 of FIG. 1). In some examples, the SLIM component 110 sends a request 210 to each mitigation component 112, 114, which send respective responses 214.

In some examples, the SLIM component 110 aggregates 216 data from the responses 204, 208, 214 as actuarial data and sends a message 218 to the actuarial service 116, the message 218 including the actuarial data. In some examples, the actuarial service 116 processes the actuarial data to provide a risk assessment and sends a message 220 to the premium engine 118, the message 220 including the risk assessment. In some examples, the premium engine 118 processes the risk assessment and generates insurance premium data based thereon. The premium engine 118 sends a message 224 to the SLIM component, the message 224 including the premium data.

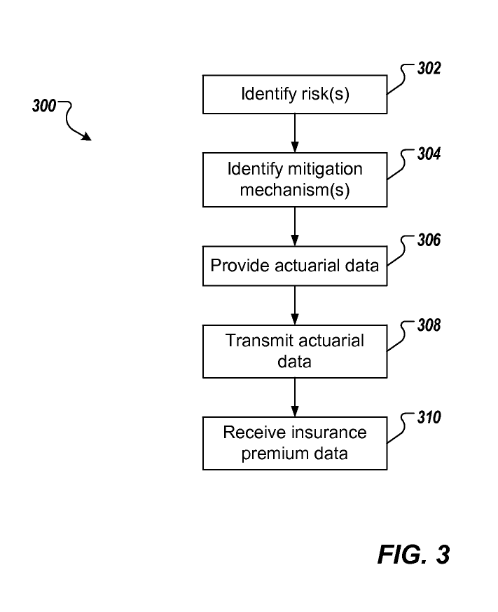

FIG. 3 is a flowchart depicting an example process 300 that can be executed in accordance with implementations of the present disclosure. In some implementations, the example process 300 can be implemented using one or more computer-executable programs that can be executed using one or more processors. For example, the example process 300 can be executed within the platform 102 of FIG. 1.

One or more risks associated with at least one computer-implemented service are identified (302). One or more mitigation mechanisms associated with at least one risk of the one or more risks are identified (304). Actuarial data is provided based on the one or more mitigations mechanisms and the at least one risk (306). The actuarial data is transmitted to one or more insurance providers (308). Insurance premium data is received (310).

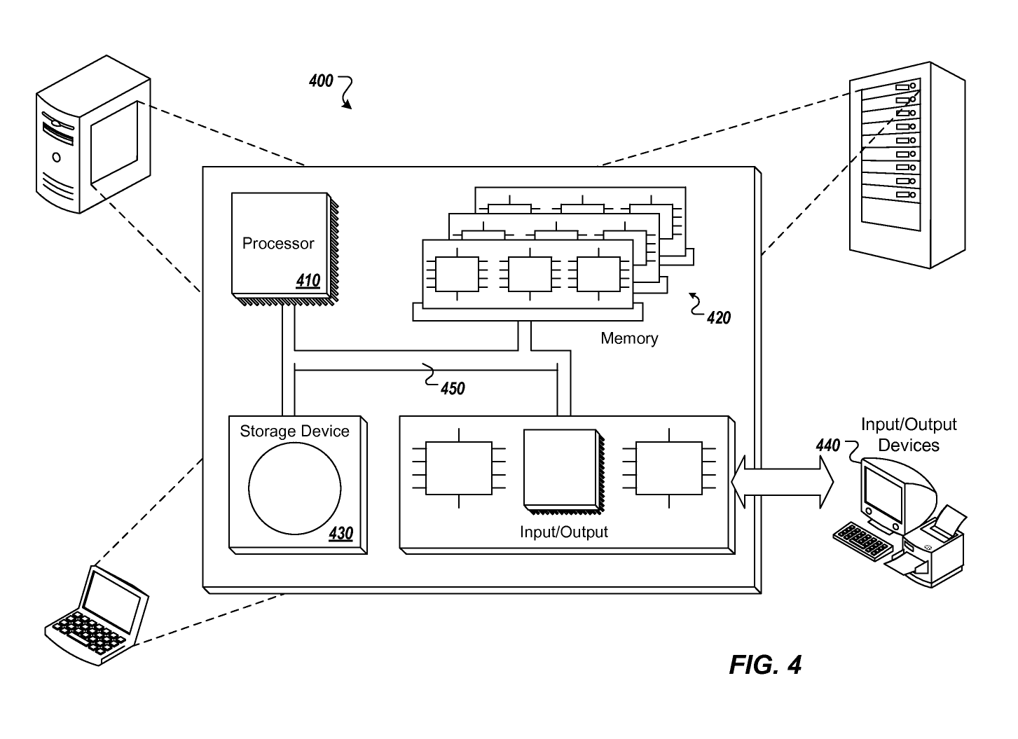

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. Each of the components 410, 420, 430, 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit. The storage device 430 is capable of providing mass storage for the system 400. In one implementation, the storage device 430 is a computer-readable medium. In various different implementations, the storage device 430 may be a floppy disk device, a hard disk device, an optical disk device, or a tape device. The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for providing insurance information for one or more platforms, each platform hosting at least one computer-implemented service, the method being executed using one or more processors and comprising:
identifying one or more risks associated with the at least one computer-implemented service;
identifying, by the one or more processors, one or more mitigation mechanisms associated with at least one risk of the one or more risks;
providing, by the one or more processors, actuarial data based on the one or more mitigations mechanisms and the at least one risk;
transmitting, by the one or more processors, the actuarial data to one or more insurance providers; and
receiving, by the one or more processors, insurance premium data, the insurance premium data being provided based on the actuarial data.

2. The method of claim 1, wherein each mitigation mechanism of the one or more mitigation mechanisms comprises a mitigation component that is provided on a platform hosting the at least one computer-implemented service.

3. The method of claim 1, wherein each mitigation mechanism comprises at least one of a technical-level mitigation mechanism and a process-level mitigation mechanism.

4. The method of claim 3, wherein the process-level mitigation mechanism mitigates risks associated with a platform hosting the at least one computer-implemented service.

5. The method of claim 3, wherein the process-level mitigation mechanism mitigates risks associated with the at least one computer-implemented service.

6. The method of claim 1, further comprising executing, by the one or more processors, an orchestration platform component and a landscape management component that perform providing actuarial data.

7. The method of claim 1, further comprising executing, by the one or more processors, a service landscape insurance management (SLIM) component that performs providing actuarial data and transmitting actuarial data.

8. The method of claim 1, wherein the actuarial data is transmitted to the one or more insurance providers in real-time.

9. The method of claim 1, wherein the actuarial data is periodically transmitted to the one or more insurance providers.

10. A non-transitory computer-readable storage medium coupled to one or more processors and having instructions stored thereon which, when executed by the one or more processors, cause the one or more processors to perform operations for providing insurance information for one or more platforms, each platform hosting at least one computer-implemented service, the operations comprising:
identifying one or more risks associated with the at least one computer-implemented service;
identifying one or more mitigation mechanisms associated with at least one risk of the one or more risks;
providing actuarial data based on the one or more mitigations mechanisms and the at least one risk;
transmitting the actuarial data to one or more insurance providers; and
receiving insurance premium data, the insurance premium data being provided based on the actuarial data.

11. A system, comprising:
one or more processors; and
a computer-readable storage device coupled to the one or more processors and having instructions stored thereon which, when executed by the one or more processors, cause the one or more processors to perform operations for providing insurance information for one or more platforms, each platform hosting at least one computer-implemented service, the operations comprising:
identifying one or more risks associated with the at least one computer-implemented service;
identifying one or more mitigation mechanisms associated with at least one risk of the one or more risks;
providing actuarial data based on the one or more mitigations mechanisms and the at least one risk;
transmitting the actuarial data to one or more insurance providers; and
receiving insurance premium data, the insurance premium data being provided based on the actuarial data.
